(19) United States
(12) Patent Application Publication
(10) Pub. No.: US 2018/0047051 A1
(43) Pub. Date: Feb. 15, 2018

(54) METHOD AND SYSTEM OF JACKPOT MARKETING ADVERTISEMENT

(71) Applicant: Cheol Sung LEE, Gangwon-do (KR)

(72) Inventor: Cheol Sung LEE, Gangwon-do (KR)

(21) Appl. No.: 15/534,492

(22) PCT Filed: Sep. 16, 2015
(86) PCT No.: PCT/KR2015/009709

§ 371 Date: Oct. 27, 2017

(30) Foreign Application Priority Data
Dec. 12, 2014 (KR) 10-2014-0179741

(51) Int. Cl. G06Q 30/02

(52) U.S. Cl. CPC G06Q 30/0251; G06Q 30/0239; G06Q 30/0277; G06Q 30/0273

(57) ABSTRACT

A method and a system of jackpot marketing advertisement are provided. A method of jackpot marketing advertisement according to an embodiment of the present invention may include a step of setting jackpot advertisement conditions for individual advertisements by an advertiser; a step of providing an opportunity to enter for individual jackpots as a reward for reading a consumer's individual advertisement; a step of paying prize money as a part of the individual jackpot by selecting a prizewinner who satisfies the winning condition of the corresponding round; a step of accumulating and controlling the prize money to be transfer to the prizewinner of the next round when there is no selected prizewinner; and a step of repeating the providing step to the controlling step several times until the termination conditions of the individual advertisement are satisfied.

### CROSS-REFERENCE TO RELATED APPLICATIONS

This patent application is a national-stage application of PCT application No. PCT/KR2015/009709 filed on Sep. 16, 2016 which claims priority under 35 U.S.C. § 119to Korean Patent Application No. 10-2014-017974, filed on Dec. 12, 2014, in the Korean Intellectual Property Office, the disclosures of which are incorporated by reference herein in their entireties.

### TECHNICAL FIELD

The present invention relates to a jackpot marketing advertisement method and system, and in particular, to a jackpot marketing advertisement method and system that provide prize money as a reward for viewing advertisements.

### DISCUSSION OF RELATED ART

Advertisement marketing schemes are based generally on methodology for rewarding customers with various advantages for the purpose of attracting customers. In particular, one advertisement scheme over the wide-spread Internet and mobile communications is to provide a benefit to the customer selected by lottery when the click count for an advertisement is a predetermined number or more.

As such conventional way, however, targets a number of unspecified people, the number of people who actually view or read the advertisement might be identical to the click count. Thus, the scheme fails to give an exact measurement as to advertisement effects.

Moreover, the customers may not expect a high reward for viewing the advertisement because the reward is limited to the advertisement cost for a single product. As such, conventional advertisement schemes would not work in an effective manner.

### SUMMARY

To address the issues of the conventional art, according to an embodiment of the present invention, there are provided a jackpot marketing advertisement method and system that may count customers who view an advertisement, simultaneously provide rewards, and significantly enhance the degree of reward as compared with that of a single advertisement.

To address the above issues, according to an aspect of the present invention, there is provided a method for a jackpot marketing advertisement method. The jackpot marketing advertisement method may comprise the steps of setting a jackpot advertisement condition for an individual advertisement by an advertiser, wherein the jackpot advertisement condition includes the number of drawings of a winner, a winning condition per drawing, and prize money amount per drawing, and wherein a sum of prize money amounts is the same or smaller than an advertisement cost for the individual advertisement, providing a chance to enter for an individual jackpot as a reward for the customer to view the individual advertisement, wherein the individual jackpot corresponds to a sum of a predetermined portion of the advertisement cost for the individual advertisement and a predetermined portion of prize money when there is no winner of a previous drawing, and the customer's view of the individual advertisement is performed through advertisement media that may authenticate identity information about the customer, choosing a winner who meets the winning condition per drawing and providing the winner with a predetermined portion of the individual jackpot as prize money, accruing and adjusting the prize money by carrying the prize money over to a winner of a subsequent drawing when the winner is not chosen, and repeatedly performing the providing step and the adjusting step multiple times until a termination condition for the individual advertisement is met.

According to an embodiment of the present invention, the jackpot marketing advertisement method may further comprise the steps of providing a chance to enter for a higher jackpot to the customer who viewed the individual advertisement after choosing the winner, wherein the higher jackpot is configured in a multi-level hierarchical structure, and the higher jackpot corresponds to a sum of a predetermined portion of the individual advertisement cost for multiple jackpots belonging to a lowest level in the multi-level hierarchical structure, a predetermined portion of prize money for multiple lower jackpots belonging to the higher jackpot, and a predetermined ratio of prize money when there is no winner in a previous drawing for the higher jackpot, choosing a winner who meets a preset winning condition and providing the winner with a predetermined portion of the higher jackpot as prize money, and accruing and adjusting the prize money by carrying the prize money over to a winner of a subsequent drawing for the higher jackpot unless the winner for the higher jackpot is chosen.

According to an aspect of the present invention, there is provided a jackpot marketing advertisement server. The jackpot marketing advertisement server may comprise an advertisement manager setting a jackpot advertisement condition for an individual advertisement by an advertiser, wherein the jackpot advertisement condition includes the number of drawings of a winner, a winning condition per drawing, and prize money amount per drawing, and wherein a sum of prize money amounts is the same or smaller than an advertisement cost for the individual advertisement and an individual jackpot manager providing a chance to enter for an individual jackpot as a reward for the customer to view the individual advertisement, choosing a winner who meets the winning condition per drawing and providing the winner with a predetermined portion of the individual jackpot as prize money, accruing and adjusting the prize money by carrying the prize money over to a winner of a subsequent drawing when the winner is not chosen, and repeatedly performing the providing step and the adjusting step multiple times until a termination condition for the individual advertisement is met, wherein the individual jackpot corresponds to a sum of a predetermined portion of the advertisement cost for the individual advertisement and a predetermined portion of prize money when there is no winner of a previous drawing, and the customer's view of the individual advertisement is performed through advertisement media that may authenticate identity information about the customer.

According to an embodiment of the present invention, the jackpot marketing advertisement server may further comprise a higher jackpot manager providing a chance to enter for a higher jackpot to the customer who viewed the individual advertisement after choosing the winner, choosing a winner who meets a preset winning condition and providing the winner with a predetermined portion of the higher jackpot as prize money, and accruing and adjusting the prize money by carrying the prize money over to a winner of a subsequent drawing for the higher jackpot unless the winner for the higher jackpot is chosen, wherein the higher jackpot is configured in a multi-level hierarchical structure, and the higher jackpot corresponds to a sum of a predetermined portion of the individual advertisement cost for multiple jackpots belonging to a lowest level in the multi-level hierarchical structure, a predetermined portion of prize money for multiple lower jackpots belonging to the higher jackpot, and a predetermined ratio of prize money when there is no winner in a previous drawing for the higher jackpot.

According to another aspect of the present invention, there is provided a jackpot marketing advertisement system. The jackpot marketing advertisement system may comprise the above-described jackpot marketing advertisement server, a customer's terminal viewing the individual advertisement, advertisement media used to view the individual advertisement, an authentication server authenticating ID information about the customer's terminal provided from the advertisement medial, and an advertiser's terminal setting the individual advertisement.

According to still another aspect of the present invention, there is provided a recording medium storing a program executed by a processor. The program may include codes to enable the processor to perform the steps of the above-described method.

According to an embodiment of the present invention, the jackpot marketing advertisement method and system enable simultaneous rewarding for viewing an advertisement by a multi-level jackpot hierarchical structure while significantly raising customers' expectancy as compared with individual advertisement costs, thus enabling attracting customers effectively and quickly.

According to an embodiment of the present invention, advertisement effects for advertisements may efficiently and precisely be produced based on customers' identification information, and potential customers that may be attracted by advertisements may easily be analyzed.

Further, according to an embodiment of the present invention, despite use of a single advertisement cost, considerable prize money may be offered to customers by a multi-level jackpot hierarchical structure, contributing to advertisement economy.

### BRIEF DESCRIPTION OF THE DRAWINGS

FIG. 1 is a block diagram schematically illustrating a jackpot marketing advertisement system according to an embodiment of the present invention.

FIG. 2 is a hierarchy diagram illustrating the concept of a jackpot marketing advertisement according to an embodiment of the present invention.

FIG. 3 is a concept view illustrating prize money per step and accrued money of a jackpot marketing advertisement according to an embodiment of the present invention.

FIG. 4 is a flowchart illustrating a jackpot marketing advertisement method according to an embodiment of the present invention.

FIG. 5 is a flowchart illustrating a process for entering for a group jackpot of a jackpot marketing advertisement method according to an embodiment of the present invention.

FIG. 6 is a flowchart illustrating a process for entering for a global jackpot of a jackpot marketing advertisement method according to an embodiment of the present invention.

FIG. 7 is a block diagram illustrating a configuration of a jackpot marketing advertisement server according to an embodiment of the present invention.

FIG. 8 is a block diagram illustrating a database of a jackpot marketing advertisement server according to an embodiment of the present invention.

### DETAILED DESCRIPTION OF EXEMPLARY EMBODIMENTS

Hereinafter, embodiments of the present invention are described in detail with reference to the accompanying drawings to easily be practiced by one of ordinary skill in the art to which the present invention pertains. The present invention may be implemented in other various forms and is not limited to the embodiments set forth herein. For clarity purposes, parts of the drawings irrelevant to the description are excluded from the description. The same or similar denotations are used to refer to the same or similar elements throughout the specification.

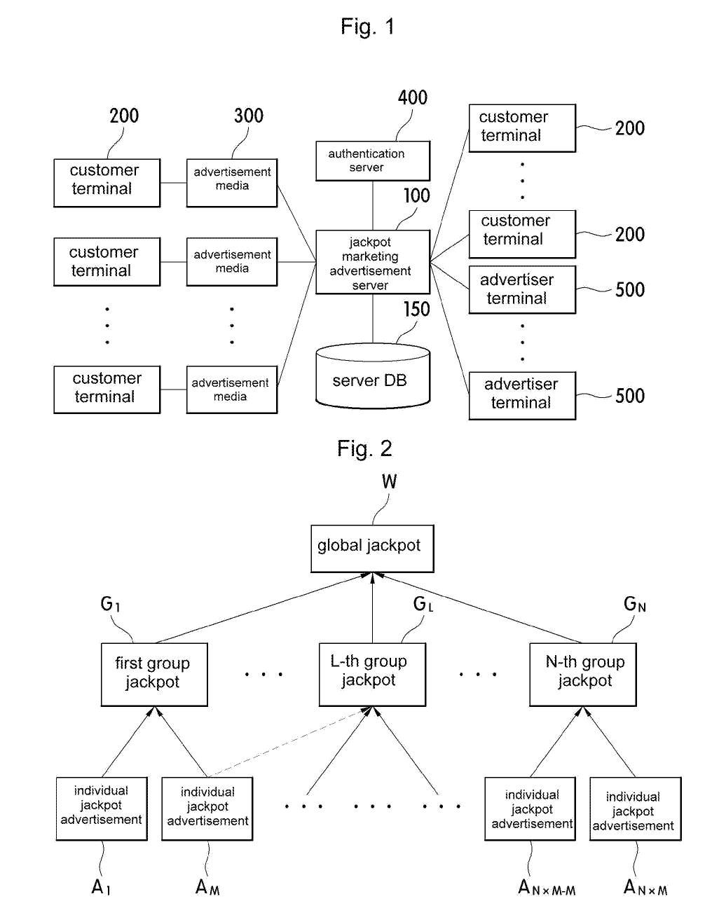

FIG. 1 is a block diagram schematically illustrating a jackpot marketing advertisement system according to an embodiment of the present invention. A jackpot marketing advertisement system, according to an embodiment of the present invention, is described below in detail with reference to the drawings.

Referring to FIG. 1, a jackpot marketing advertisement system 10 according to an embodiment of the present invention includes a jackpot marketing advertisement server 100, a customer terminal 200, an advertisement media 300, an authentication server 400, and an advertiser terminal 500.

The jackpot marketing advertisement server 100 may upload a jackpot advertisement directly or through the advertisement media 300. The jackpot marketing advertisement server 100 may choose a winner according to a multi-level jackpot hierarchical structure as customers view the advertisement and provide prize money to the winner as a reward for viewing the advertisement.

The customer terminal 200 may connect to the advertisement media 300 or the jackpot marketing advertisement server 100 so that the customer can view an individual jackpot advertisement through the advertisement media 300, and the customer terminal 200 may receive information about providing prize money from the jackpot marketing advertisement server 100. The customer terminal 200 may include a portable information device, such as a smartphone, and a personal computer (PC).

Individual jackpot advertisements may be uploaded on the advertisement media 300. The advertisement media 300 may include an online advertisement server and an offline advertisement media that may be identified by customers. For example, the online advertisement server may include various websites that provide advertisements online, and the offline advertisement media may include newspapers, magazines, or RF cards for advertisement in which case the customer may identify to view the advertisement by sending his/her customer information and an identification number, which is provided through the media, to the jackpot marketing advertisement server 100.

The authentication server 400 may authenticate identification (ID) information about the customer terminal 200 which is provided from the advertisement media 300 or the jackpot marketing advertisement server 100. The authentication server 400 may provide part of the ID information of the customer to the jackpot marketing advertisement server 100.

The advertiser terminal 500 may be connected to the jackpot marketing advertisement server 100 by the advertiser to set an individual jackpot advertisement and to receive refund information about a remaining advertisement cost from the jackpot marketing advertisement server 100. The advertiser terminal 500 may include a portable information device, such as a smartphone, and a personal computer.

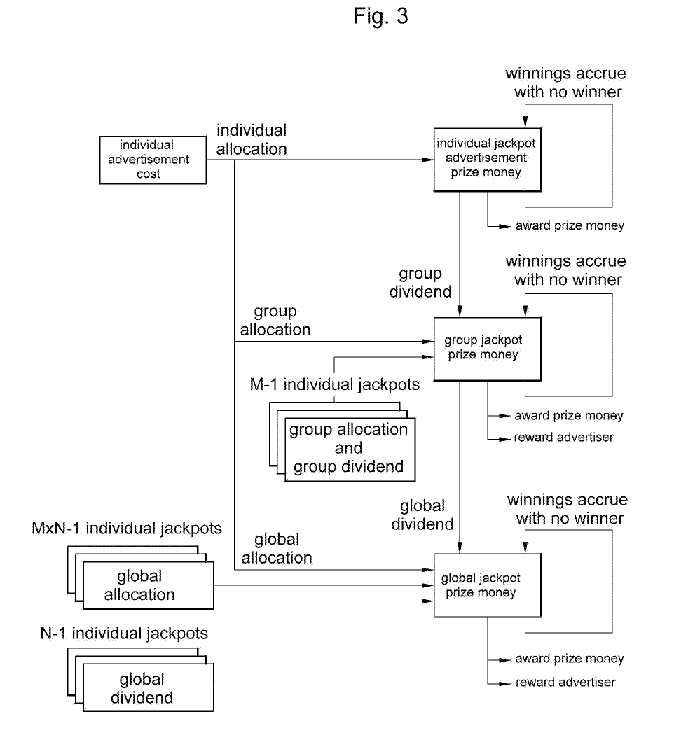

The concept of a jackpot marketing advertisement according to an embodiment of the present invention is described below with reference to FIGS. 2 and 3.

FIG. 2 is a hierarchy diagram illustrating the concept of a jackpot marketing advertisement according to an embodiment of the present invention. FIG. 3 is a concept view illustrating prize money per step and accrued money of a jackpot marketing advertisement according to an embodiment of the present invention.

A jackpot marketing advertisement according to the present invention may be configured in a multi-level jackpot hierarchical structure, wherein individual jackpot advertisements corresponding to individual advertisements that an advertiser provides constitute the lowest level in the jackpot hierarchical structure. Multiple individual jackpot advertisements may be grouped into one group jackpot. Multiple group jackpots may be grouped into a next higher-level group jackpot. Such a jackpot hierarchical structure may be configured in the multi-level structure. An example in which the jackpot hierarchical structure is configured to have three levels is described herein, as shown in FIG. 2.

Referring to FIG. 2, a global jackpot W may consist of N group jackpots G, and each group jackpot G may consist of M individual jackpot advertisements A. However, the present invention is not limited thereto. For example, the group jackpot G may consist of different numbers of individual jackpot advertisements A.

In FIG. 2, the individual jackpot advertisements A are jackpots for choosing a winner and awarding prize money as customers view the advertisements. The group jackpots G are jackpots that may be entered for when the view count for the individual jackpot advertisements A is a predetermined number or more. For example, the group jackpot G may be one obtained by grouping individual jackpot advertisements A by, e.g., region, customer's age group, customer's age, or weight for individual advertisement. Here, the individual jackpot advertisement A may be set to belong to multiple group jackpots G, rather than only a single group jackpot G, and in such case, when the view count for the individual jackpot advertisement A is a predetermined number or more, multiple related group jackpots G may simultaneously be entered for.

The global jackpot W is a jackpot that may be entered, for when the entry count for the group jackpots G is a predetermined number or more, and in the instant embodiment, the global jackpot W, as the highest-level jackpot, may include all the individual advertisements. For example, the global jackpot W may include all individual advertisements made worldwide.

The group jackpots G and the global jackpot W are notionally configured according to the individual jackpot advertisements A, and no actual advertisement corresponding thereto is performed. Thus, as a customer views an individual advertisement, the customer may simultaneously win the individual jackpot advertisement A, the group jackpot G, and the global jackpot W.

According to an embodiment of the present invention, the jackpot marketing advertisement may allow the customer to expect a chance of winning various rewards by merely viewing individual advertisements along with a significantly increased reward, i.e., prize money, as compared with individual advertisements as shown in FIG. 3, promoting customers to view advertisements and effectively attracting customers.

More specifically, an individual advertisement cost for an individual jackpot advertisement A is divided into allotments for the individual jackpot advertisement A, a group jackpot G, and a global jackpot W in a predetermined ratio selected by the advertiser, as shown in FIG. 3. Accordingly, the prize money for an individual jackpot advertisement A basically consists of the prize money set for the individual jackpot advertisement per drawing by the advertiser. The prize money in the drawing where no winner is chosen is carried over to the next drawing and accrued for the winner of the next drawing. Thus, as the drawings where no winners are chosen for the individual jackpot advertisement A increase, the prize money is further accrued. Here, when a winner is chosen, the prize money set per drawing by the advertiser or the sum of the prize money per drawing and the accrued money for the previous drawings may be awarded to the winner. In this case, upon choosing a winner for the individual jackpot advertisement A, i.e., for both where a winner is chosen and where no winner is chosen, a predetermined portion of the prize money calculated thus far may be provided as a group dividend tor the group jackpot G where the individual jackpot advertisement A belongs.

The prize money for the group jackpot G may basically consist of the sum of a predetermined portion of an individual advertisement cost, which is provided as a group allocation from each of a plurality of individual jackpot advertisements A, and a group dividend provided when a winner is chosen. For example, the basic prize money for the group jackpot G may consist of the sum of allocations from M individual jackpot advertisements A, which constitute the group jackpot G, and the group dividend. Where no winner is chosen in a drawing for the group jackpot G, the prize money may be carried over and added to the next drawing, and the prize money accrued as there are no winners is added to the basic prize money. Similar to individual jackpot advertisements A, the prize money for the group jackpot G thus increases as more draws occur. Since the sum of the amounts provided from the plurality of individual jackpot advertisements A in the group jackpot G is the prize money for the group jackpot G, the prize money for the group jackpot G may further increase. In this case, when a winner is chosen for the group jackpot G, the sum of the allocations from the individual jackpot advertisements A in the group jackpot G, the group dividend, and the money accrued as there is no winner in the previous drawings for the group jackpot G may be awarded to the winner. Simultaneously, a predetermined portion of the calculated prize money may be provided, as a reward, to the advertiser. At this time, upon choosing a winner for the group jackpot G, i.e., for both where a winner is chosen and where no winner is chosen, a predetermined portion of the prize money calculated thus far may be provided as a global dividend of the global jackpot W where the group jackpot G belongs.

Prize money for the global jackpot W may basically consist of the sum of a predetermined portion of the individual advertisement cost, which is provided as a global allocation from each of all the individual jackpot advertisements A and a global dividend provided upon choosing a winner for a group jackpot. For example, the basic prize money for the global jackpot W may consist of the sum of allocations from all of M×N individual jackpot advertisements A constituting the global jackpot W and global dividends from N group jackpots G. Where no winner in a drawing is chosen for the global jackpot W, the prize money is carried over to the winner of the next drawing so that accrued prize money for the draws is added to the basic prize money. Therefore, the prize money for the global jackpot W increases as more draws occur in the drawings in a similar manner to the prize money for individual jackpot advertisement A or the prize money for group jackpot G, and since the sum of the amounts of money awarded from all the individual jackpot advertisements A and the group jackpots G is the prize money for the global jackpot W, the prize money for the global jackpot W may further increase. Here, when a winner is chosen for the global jackpot W, the sum of the allocations from the all the individual jackpot advertisements A, the global dividends from the group jackpots G, and the accrued money from the previous draws for the global jackpot W may be awarded to the winner. Simultaneously, a predetermined portion of the prize money may be provided, as a reward, to the advertiser.

As such, rewarding the customers with the group jackpots and global jackpot in association with the individual jackpot advertisements, together with the hierarchical structure of jackpots, may attract more customers. Further, a predetermined portion of the reward is returned to the advertiser, and this way enables securing more advertisers.

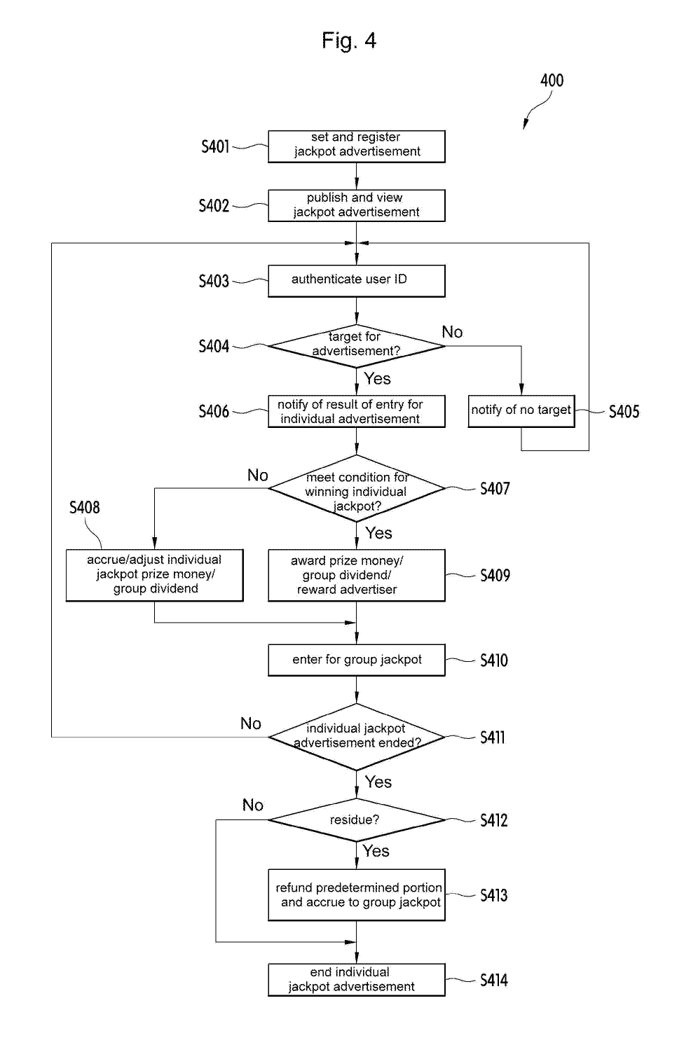

A jackpot marketing advertisement method is described below with reference to FIGS. 4 to 6 according to an embodiment of the present invention.

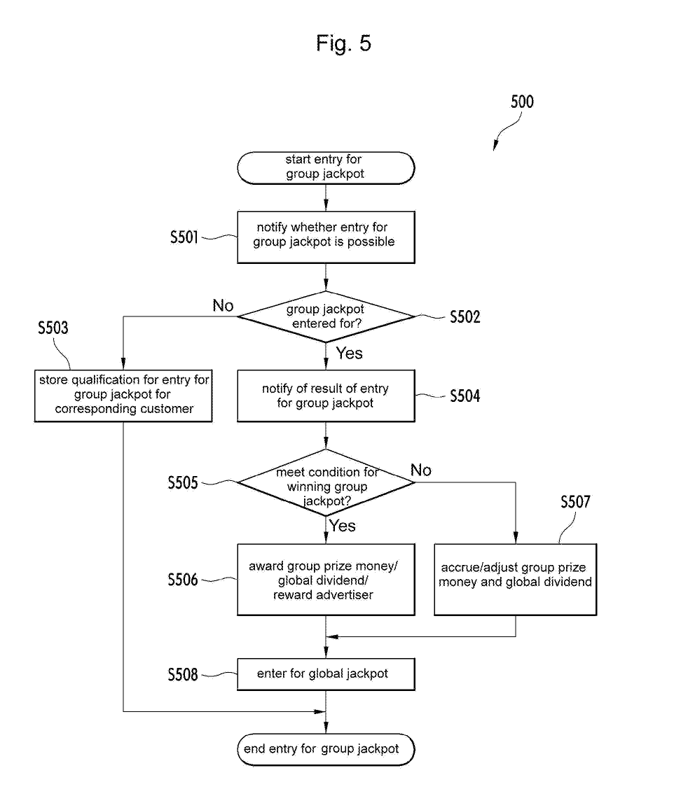

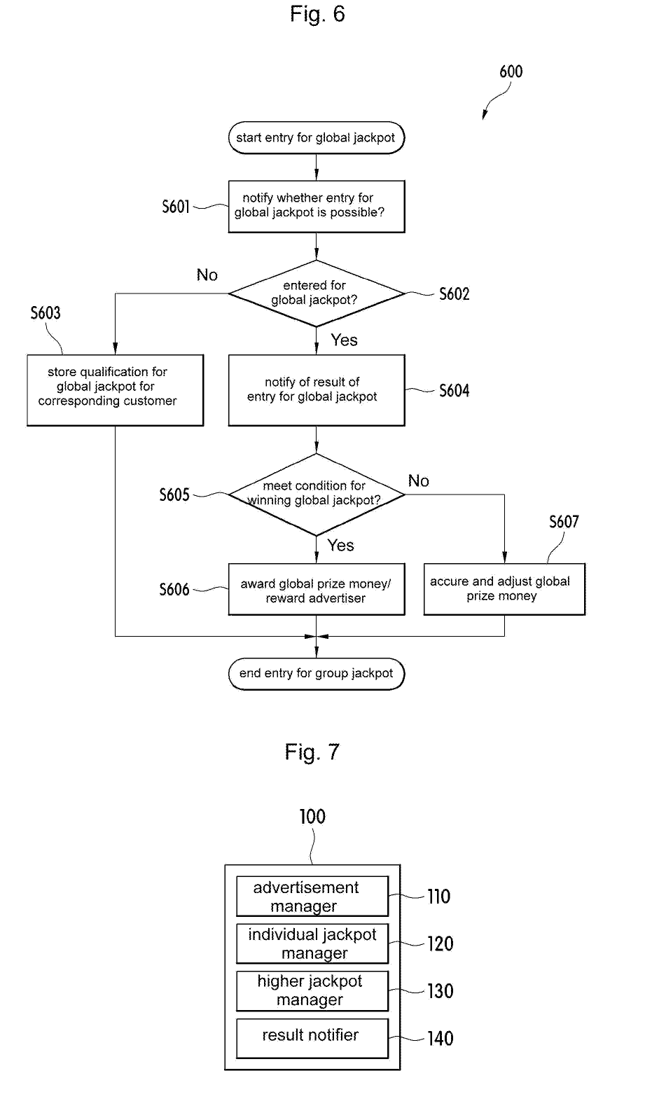

FIG. 4 is a flowchart illustrating a jackpot marketing advertisement method according to an embodiment of the present invention. FIG. 5 is a flowchart illustrating a process for entering for a group jackpot of a jackpot marketing advertisement method according to an embodiment of the present invention. FIG. 6 is a flowchart illustrating a process for entering for a global jackpot of a jackpot marketing advertisement method according to an embodiment of the present invention.

According to an embodiment of the present invention, the jackpot marketing advertisement method 400 includes the step S401 of setting and registering a jackpot advertisement, the steps S402 to S406 of publishing the jackpot advertisement and choosing a winner who views the jackpot advertisement, the steps S407 to S411 of providing prize money according to individual jackpot winning conditions, and the steps S412 and S414 of returning a residue of the prize money to the advertiser and terminating the individual advertisement. Here, nothwithstanding that the jackpot marketing advertisement method according to an embodiment of the present invention may be constituted of multi-stage jackpot levels, an example is described below in which the method consists of three levels, individual jackpots, group jackpots, and a global jackpot as shown in FIGS. 2 and 3.

More specifically, the jackpot marketing advertisement server 100 may enable the advertiser to set jackpot advertisement conditions for the individual advertisement (step S401) as illustrated in FIG. 4. Here, the jackpot advertisement conditions may include the number of drawings to choose a winner, conditions for winning per drawing, and prize money per drawing. More specifically, the number of drawings may be the number of times to distribute and provide the prize money for the individual advertisement. The prize money per drawing may be an amount for the drawing which is obtained by dividing the advertisement cost for the individual jackpot advertisement according to the settings made by the advertiser. Thus, the sum of the amounts per drawing may be the same or smaller than the advertisement cost for the individual advertisement. The conditions for winning may include a turn of view of the advertisement by a customer, e.g., 1000^{th} view, and a particular event. The particular event may include at least one of the weather, the stock price, and an event published by the news or the newspaper. In this case, the advertiser may set suitable customers for the individual advertisement to block off the entry for jackpot by customers who are irrelevant to the corresponding product. The advertiser may also set a plurality of group jackpots associated with the individual advertisement to provide more chances to enter for a group jackpot in association with the individual jackpot advertisement. The setting and registration of the individual advertisement may be performed by accessing or connecting to the jackpot marketing advertisement server 100, e.g., by way of the advertiser terminal 500.

Next, the advertiser's individual advertisement may be published through the advertisement media 300. Customers may view the advertisement using customer terminals 200 (step S402). At this time, the customers' view of the individual advertisement may be conducted through the advertisement media 300 that may authenticate the customers' ID information. In other words, upon viewing the advertisement, the customer terminal 200 may transmit the customer's ID information to the jackpot marketing advertisement server 100 through the advertisement media 300. Here, the advertisement media 300 may include an online advertisement server and offline advertisement media capable of identifying the customer. For example, the online advertisement server may include various websites that provide advertisements online, and the offline advertisement media may include a newspaper or magazine or a RF card for advertisement. In this case, the customer may confirm to view the advertisement by sending his/her customer information and an ID number provided through the media to the jackpot marketing advertisement server 100. Alternatively, the customer terminal 200 may view the advertisement published by the jackpot marketing advertisement server 100 directly without passing through the advertisement media 300.

Next, the received customer ID information received from the customer terminal 200 may be transmitted from the jackpot marketing advertisement server 100 to the authentication server 400 to authenticate the customer (step S403). At this time, the jackpot marketing advertisement server 100 may receive the ID information of the user from the authentication server 400. Meanwhile, the authentication server 400 may not separately be configured in which case the jackpot marketing advertisement server 100 may send a request for the customer's basic information, such as age, gender, or region, to the customer terminal 200 and receive the basic information from the customer terminal 200. Further, the jackpot marketing advertisement server 100 may previously gather the customer's ID information through a subscription process to enter for a jackpot by entering for the individual advertisement.

Then, the jackpot marketing advertisement server 100 may determine whether the ID information of the customer who viewed the individual advertisement indicates that the customer is a preset, proper target for advertisement (step S404). Upon determining that the customer is not the proper target for advertisement, e.g., when the product advertised is a baby diaper, and the customer who viewed the advertisement is one who is less relevant to the advertised product, e.g., a minor or bachelor, or when the customer is one within a category which is set by the advertiser to be excluded from advertisement, the jackpot marketing advertisement server 100 notifies the customer that he/she is not the one for which advertisement is targeted, blocks off the chance to enter for jackpot (step S405). and proceeds with step S403 to wait for a next customer to view the advertisement.

Upon determining in step S404 that the customer who viewed the advertisement is a proper target for advertisement, the jackpot marketing advertisement server 100 may provide the customer with a chance to enter for an individual jackpot as a reward for viewing the individual advertisement and notify the customer of a result of the entry (step S406). Here, as the result of entry, the jackpot marketing advertisement server 100 may notify the customer that the customer has won or failed or that his/her entry is improper. In particular, an example where the entry is improper may be when the customer has viewed the same individual jackpot advertisement. In this case, if the same customer reviews the individual advertisement after a predetermined period of time, his/her review of the individual advertisement may be determined to be a new view by the advertiser's settings so that the customer may be given a chance to enter for jackpot. When the same customer views a predetermined number of individual jackpot advertisements or more, winch belongs to a particular group jackpot, within a predetermined period of time, e.g., when the same customer views ten or more individual jackpot advertisements for one day, the jackpot marketing advertisement server 100 may abstain from providing a chance for entry and notify the customer that his/her entry is improper. A winner may first be chosen according to preset winning conditions within a time previously set by the advertiser. Thus, the customer may check if he/she wins or fails immediately when viewing the individual advertisement. Here, a notification for the result of entry may be provided through a screen displayed on the customer terminal 200 when the advertisement published by the jackpot marketing advertisement server 100 or the advertisement media 300 is clicked, or through a screen displayed on the customer terminal 200 when the ID number provided through the advertisement media 300 is transmitted to the jackpot marketing advertisement server 100. Or the result of entry may be provided to the customer terminal 200.

Next, the jackpot marketing advertisement server 100 may determine whether winning conditions for the individual jackpot are met for the customer (step S407). Upon determining that the winning conditions preset by the advertiser are not met, i.e., when no winner is chosen for the drawing within the time set by the advertiser, the jackpot marketing advertisement server 100 may accrue and adjust the prize money by carrying the prize money for the drawing over to a winner of a next drawing (step S408). At this time, a predetermined portion of the prize money carried over may be provided as a dividend for a group jackpot.

Upon determining in step S407 that the winning conditions are met for the customer, i.e., upon choosing a winner who meets the winning conditions for the drawing, a predetermined portion of the individual jackpot may be provided as prize money (step S409). At this time, e.g., a voucher for providing the prize money may be sent from the jackpot marketing advertisement server 100 to the customer terminal 200. Here, the prize money awarded, i.e., the individual jackpot, may correspond to the sum of a predetermined portion (i.e., an individual allocation) of the advertisement cost for the individual advertisement and a predetermined portion (i.e., an amount accrued for no winning) of prize money when there is no winner in the previous drawing. A predetermined portion of the prize money for the individual jackpot may be provided as a dividend of the group jackpot while another predetermined portion of the prize money may simultaneously be provided as a reward to the advertiser. At this time, a voucher for rewarding may be sent to the advertiser terminal 500.

The jackpot marketing advertisement server 100 may provide a chance to enter for a higher jackpot (e.g., a group jackpot as shown in FIG. 4 or a global jackpot as shown in FIG. 5) to the customer who viewed the individual advertisement (step S410). At this time, the jackpot marketing advertisement server 100 may provide the chance to enter for a group jackpot to the customer when the customer views multiple individual advertisements a predetermined number of times or more. Examples of entry for a group jackpot or global jackpot are described below with reference to FIGS. 5 and 6.

Next, the jackpot marketing advertisement server 100 may determine whether conditions for terminating the individual advertisement are met (step S411). Here, the termination of the individual advertisement may be done when at least one of the following conditions is met:

Preset number of times of choosing winner of individual advertisement≦number of times of choosing the above winner

Preset advertisement cost for individual advertisement≦prize money awarded to the above customer

Preset number of customers of individual advertisement≦number of customers who views the individual advertisement

Preset number of target customers after a preset time> number of customers who view

Upon determining in step S411 that the termination conditions for the individual advertisement are not met, the jackpot marketing advertisement server 106 may return to step S403 to repeat steps S403 to S410.

Upon determining in step S411 that the termination conditions for the individual advertisement are met, i.e., when the advertisement cost for the individual advertisement runs out, when the number of customers who viewed the advertisement exceeds the number of target customers, or when it fails to reach the number of target customers even after the preset time has elapsed, the jackpot marketing advertisement server 100 determines whether there is a residue, i.e., the remainder of the advertisement cost for the individual advertisement except for the prize money awarded to the winner and the dividend for the higher jack pot to terminate the individual jackpot advertisement (step S412). Upon determining that there is a residue, i.e., when the advertisement cost for the individual advertisement did not run short yet, the jackpot marketing advertisement server 100 may return a predetermined portion of the residue to the advertiser and accrue another predetermined portion of the residue, e.g., as a dividend for a group jackpot (step S413). At this time, to return the reside to the advertiser, the jackpot marketing advertisement server 100 may send, e.g., a voucher for the returning amount, to the advertiser terminal 500.

Upon determining in step S412 that there is no residue, or after step S413, the jackpot marketing advertisement server 100 may terminate the individual jackpot advertisement (step S415). At this time, even after the termination of the individual jackpot advertisement, the higher jackpot corresponding to the individual jackpot advertisement may be maintained.

Entry for a group jackpot is described below in greater detail with reference to FIG. 5

Entry 500 of a group jackpot may be imitated upon providing a chance to enter for a higher jackpot, e.g., a group jackpot, to the customer who viewed the individual jackpot advertisement, as denoted in step S410 of FIG. 4.

At this time, the jackpot marketing advertisement server 100 may notify the customer whether he/she can enter for the group jackpot depending on the number of times of view, by the customer, of multiple individual advertisements which belong to the group jackpot (step S501). In other words, the jackpot marketing advertisement server 100 may notify the customer that he/she can enter for the group jackpot when the number of times of view by the customer of the multiple individual advertisements within the group jackpot is a predetermined number or more, and that the customer cannot otherwise. At this time, the notification of whether to enter for the group jackpot may be conducted simultaneously or in a similar manner to the notification of the result of entry for the individual advertisement of step S406 of FIG. 4, and no further detailed description thereof is given below.

Next, the jackpot marketing advertisement server 100 may determine whether the customer applies for the group jackpot or not by his/her choice (step S502). When the customer chooses not to enter for the group jackpot, the jackpot marketing advertisement server 100 may store the customer's qualification to enter for group jackpot and terminate the process of entering for group jackpot (step S503). At this time, since entry for a group jackpot is provided when the number of times of view of multiple individual advertisements within the group jackpot is a predetermined time or more, the jackpot marketing advertisement server 100 may increase the number of times of view of the multiple individual advertisements within the group jackpot for the customer and store the same.

Upon determining in step S502 that the customer chooses to enter for the group jackpot, the jackpot marketing advertisement server 100 may notify the customer of the result of entry for the group jackpot (step S504). At this time, the number of times of view of the multiple individual advertisements within the group jackpot for the customer may be initialized. The notification of the result of entry for group jackpot may be carried out in a similar manner to the notification of the result of entry for step S406 of FIG. 4, and no further detailed description thereof is made below. A winner of a group jackpot may be chosen depending on preset winning conditions when the accrued amount for the group jackpot reaches an amount preset by the operator of the jackpot marketing advertisement server 100. Alternatively, the accrued amount for the group jackpot may be an amount accrued for the time between when a winner for a previous drawing is chosen for the group jackpot and when a winner for a subsequent drawing is chosen for the group jackpot.

Next, the jackpot marketing advertisement server 100 may determine whether winning conditions for the group jackpot are met for the customer (step S505). Upon determining that the winning conditions are met for the customer, i.e., upon, choosing a winner who meets the winning conditions for the drawing, the jackpot marketing advertisement server 100 may provide the customer with a predetermined portion of the group jackpot as prize money (step S506). Here, the winning conditions for the group jackpot may include the turn of entry for the group jackpot, e.g., 10000^{th} entry, and a particular event that may include at least one of the weather, stock price, and an event published by the news or newspaper. At this time, the jackpot marketing advertisement server 100 may send, e.g., a voucher for providing the prize money, to the customer terminal 200, Here, the prize money awarded, i.e.,. the group jackpot, may correspond to the sum of a predetermined portion (i.e., a group allocation) of the advertisement cost for the individual group, a predetermined portion (i.e., a group dividend) of the prize money of the individual jackpot, and a predetermined portion (i.e., an amount accrued for no winning) of group prize money when there is no winner for the group jackpot in the previous drawing. At this time, a predetermined portion of the prize money for the group jackpot may be provided as a dividend of the global jackpot while another predetermined portion of the group prize money may simultaneously be provided as a reward to the advertiser. At this time, a voucher for rewarding may be sent to the advertiser terminal 500.

Upon determining in step S505 that the winning conditions preset by the operator are not met, i.e., when no winner is chosen in the drawing upon reaching the accrued amount for the group jackpot set by the operator, the jackpot marketing advertisement server 100 may accrue and adjust the prize money by carrying the group prize money for the drawing over to the winner of the next drawing for the group jackpot (step S507).

Next, the jackpot marketing advertisement server 100 may provide a chance to enter for a group jackpot which is of a higher level than the group jackpot (step S508). At this time, the jackpot marketing advertisement server 100 may provide a chance to enter for the global jackpot when the number of entries for the group jackpot by the customer is a predetermined number or more. Such entry for the global jackpot is described below with reference to FIG. 6. Here, when no chance to enter for the global jackpot is provided,, the process of entry for the group jackpot may be terminated.

Although an example in which one group jackpot is associated with the individual jackpot advertisements has been described above in connection with the instant embodiment the present invention is not limited thereto. When a plurality of group jackpots are set in association with the individual advertisements, a chance to enter for each of the plurality of group jackpots may be provided, and thus, the entry 500 for group jackpot may simultaneously be performed for each of the plurality of group jackpots associated with the individual advertisement.

Entry for a global jackpot is described below in greater detail with reference to FIG. 6.

Entry 600 for the global jackpot may be initiated when a chance to do so is provided to the customer who entered for group jackpot a predetermined number of times or more as denoted in step S508 of FIG. 5.

At this time, the jackpot marketing advertisement server 100 may notify the customer whether he/she can enter for the global jackpot depending on the number of entries for group jackpot by the customer (step S601). In other words, the jackpot marketing advertisement server 100 may notify the customer that he/she can enter for global jackpot when the number of entries for group jackpot by the customer is a predetermined number or more and that he/she cannot otherwise. At this time, the notification of whether the customer can enter for global jackpot may be performed simultaneously or in a similar manner to the notification of the result of entry for the individual advertisement of step S406 of FIG. 4 or the notification of entry for the group jackpot of step S504 of FIG. 4, and no detailed description thereof is given below.

Next, the jackpot marketing advertisement server 100 determines whether the customer chooses to enter for the global jackpot by his choice (step S602). When the customer chooses not to enter for the global jackpot, the jackpot marketing advertisement server 100 may store the customer's qualification to enter for the global jackpot and terminate the process of entering for the global jackpot (step S603). At this time, since the entry for the global jackpot is provided when the number of entries for the group jackpot is a predetermined number or more, the jackpot marketing advertisement server 100 may increase the number of entries for the group jackpot for the customer and store the same.

Upon determining in step S602 that the customer chooses to enter for the global jackpot, the jackpot marketing advertisement server 100 may notify of the result of entry for the global jackpot (step S504). At this time, the number of entries for the group jackpot for the customer may be initialized. The notification of the result of entry for the global jackpot may be carried out in a similar manner to the notification of the result of entry for step S406 of FIG. 4 or the notification of the result of entry for step S504 of FIG. 5, and no further detailed description thereof is given below. At this time, a winner for the global jackpot may be chosen according to preset winning conditions when the accrued amount for the global jackpot reaches an amount preset by the operator of the jackpot marketing advertisement server 100. Alternatively, the accrued amount for the global jackpot may be an amount accrued for the time between when the winner for a previous drawing is chosen for the global jackpot and when the winner for a subsequent drawing is chosen for the global jackpot.

Next, the jackpot marketing advertisement server 100 may determine whether the winning conditions for the global jackpot for the customer are met (step S605). Upon determining that the winning conditions for the global jackpot are met for the customer, i.e., upon choosing a winner who meets the global winning conditions for the drawing, the jackpot marketing advertisement server 100 may provide a predetermined portion of the global jackpot as a reward (step S606). Here, the winning conditions for the global jackpot may include the turn of entry for the global jackpot, e.g., 10000^{th} entry, and a particular event that may include at least one of the weather, stock price, and an event published by the news or newspaper. At this time, e.g., a voucher for providing the global prize money may be sent from the jackpot marketing advertisement server 100 to the customer terminal 200. Here, the global prize money awarded, i.e., the global jackpot, may correspond to the sum of a predetermined portion (i.e., a global allocation) of all the individual advertisement costs, a predetermined portion (i.e., a global dividend) of the prize money for the group jackpot, and a predetermined portion (i.e., an accrued amount for no winning) of the global prize money when no winner is chosen for the global jackpot in the previous drawing. At this time, a predetermined portion of the prize money for the global jackpot may be provided to the advertiser, as a reward. At this time, to provide the reward, the jackpot marketing advertisement server 100 may send, e.g., a voucher, to the advertiser terminal 500.

Upon determining in step S605 that the winning conditions preset by the operator are not met, i.e., when no winner is chosen for the drawing upon reaching the accrued amount for the global jackpot set by the operator, the jackpot marketing advertisement server 100 may accrue and adjust the prize money by carrying the global prize money for the drawing to the winner of the subsequent drawing (step S607).

As such, the jackpot marketing advertisement server 100 may terminate the process of entry for the global jackpot after the provision of the prize money and the reward to the advertiser and the carry-over of the prize money.

As such, the jackpot marketing advertisement method according to an embodiment of the present invention may significantly raise customers' expectancy as compared with individual advertisement to attract more customers. Further, the method may draw actual customers within a short time, predict advertisement effects in an efficient and precise manner, provide an easier analysis on potential customers that might be attracted from advertisement, and lead to better economics for advertisement.

The above-described methods may be implemented by the jackpot marketing advertisement server 100 as shown in FIG. 1, and the methods may be implemented by or in a software program(s) that performs the steps in which case the program(s) may be stored or retained in a computer-readable recording medium or transmitted in/over/by/through a computer data signal(s) combined with a carrier wave over a transmitting medium or communication network.

In this case, the computer-readable recording medium, may include all types of recording devices that may store or retain data readable by a computer system, e.g., a ROM, a RAM, a CD-ROM, a DVD-ROM, a DVD-RAM, a magnetic tape, a floppy disk drive (FDD), a hard disk drive (HDD), or an optical data storage device.

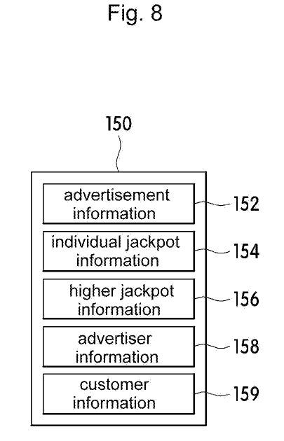

The jackpot marketing advertisement server 100 according to an embodiment of the present invention is described below in detail with reference to FIGS. 7 and 8.

FIG. 7 is a block diagram illustrating a configuration of a jackpot marketing advertisement server according to an embodiment of the present invention. FIG. 8 is a block diagram illustrating a database of a jackpot marketing advertisement server according to an embodiment of the present invention.

Referring to FIG. 7, the jackpot marketing advertisement server 100 may include an advertisement manager 110, an individual jackpot manager 120, a higher jackpot manager 130, and a result notifier 140.

The advertisement manager 110 may enable an advertiser to set jackpot advertisement conditions for an individual advertisement. For example, the advertisement manager 110 may describe advertisement information for a target product and operation conditions for the jackpot advertisement through the advertiser terminal 500 connected with the jackpot marketing advertisement server 100.

The individual jackpot manager 120 may provide a chance to enter for the individual jackpot as a reward for a customer to view the individual advertisement and repeatedly perform the choice of a winner of the individual jackpot, depending on the prize money per drawing and winning conditions set by the advertiser and the accrual and adjustment of prize money until termination conditions for the individual advertisement are met. Where the advertisement cost does not ran short upon termination of the individual advertisement, the individual jackpot manager 120 may return a predetermined portion of the remaining advertisement cost to the advertiser. Here, the individual jackpot manager 120 may transmit vouchers for exchanging with the prize money or refund to the customer's terminal 200 and the advertiser's terminal 500.

The higher jackpot manager 130 may provide a chance to enter for a higher jackpot to the customer who viewed the individual advertisement and repeatedly perform the choice of a winner of a group jackpot and repeatedly perform the choice of a winner of the group jackpot depending on preset prize money for the higher jackpot and winning conditions for the higher jackpot, the accrual and adjustment of prize money, and the provision of a dividend. The higher jackpot manager 130 may perform such operations corresponding to the group jackpot and global jackpot as shown in FIGS. 2 and 3 and may provide the advertiser with a predetermined portion of prize money, as a reward, upon choosing the winner for the group jackpot or global jackpot Here, the higher jackpot manager 130 may transmit a voucher for exchanging with the prize money or reward to the customer's terminal 200 and the advertiser's terminal 500 to provide the prize money and the reward.

The result notifier 140 may notify of a result of choice of a winner of an individual jackpot advertisement or a higher jackpot, such as a group jackpot or global jackpot. At this time, when the customer accesses the online advertisement media 300 through the customer's terminal 200 to view the jackpot advertisement, the result notifier 140 may transmit a result of choice of a winner to the online advertisement media 300 as per a request from the online advertisement media 300. Further, when the customer accesses the jackpot marketing advertisement server 100 using the customer's terminal 200 to view the jackpot advertisement, the result notifier 140 may-transmit a result of choice of a winner to the customer's terminal 200. When the customer transmits an ID number provided through the offline advertisement media 300 to the jackpot marketing advertisement server 100, the result notifier 140 may transmit a result of choice of a winner to the customer's terminal 200.

Referring to FIG. 8, a server DB 150 may include advertisement information 152, individual jackpot information 154, higher jackpot information 156, advertiser information 158, and customer information 159.

The advertisement information 152 may include content that the advertiser intends to advertise through the advertisement media 300 or the jackpot marketing advertisement server 100.

The individual jackpot information 154 may be information about a lowest jackpot for a lowest individual advertisement in the multi-level jackpot hierarchical structure and may include information about the number of drawings of a winner, winning conditions per drawing, prize money per drawing, and a group dividend, as set by the advertiser.

The higher jackpot information 156 may be information about all higher jackpots, e.g., group jackpots and global jackpot, than the individual jackpots in the multi-level jackpot hierarchical structure and may include information about winning conditions per drawing, prize money per drawing, a higher dividend, and a reward to the advertiser as set by the operator of the jackpot marketing advertisement server 100.

The advertiser information 158 may be information about the advertiser who provides the individual jackpot advertisement and may include information for returning a residue and receiving a reward by the advertiser upon choosing a winner for a group jackpot or global jackpot.

The customer information 159 may be information about the customer who views the individual jackpot advertisement through the advertisement media 300 or the jackpot marketing advertisement server 100 and may include information for the customer to receive prize money.

By such configuration, the jackpot marketing advertisement server according to an embodiment of the present invention may significantly raise customers' expectancy as compared with individual advertisement costs to effectively attract actual customers within a short time, assess advertisement effects in an efficient and precise manner, perform easier analysis on potential customers for advertisement, and promote the economics of advertisement.

Although embodiments of the present invention have been described, the spirit of the present invention is not limited thereto, and it will readily be appreciated by one of ordinary skill in that art that various changes, modifications, or variations may be made thereto which also belong to the scope of the present invention.

1. A method for a jackpot marketing advertisement, the method comprising the steps of:
setting a jackpot advertisement condition for an individual advertisement by an advertiser, wherein the jackpot advertisement condition includes the number of drawings of a winner, a winning condition per drawing, and prize money amount per drawing, and wherein a sum of prize money amounts is the same or smaller than an advertisement cost for the individual advertisement;
providing a chance to enter for an individual jackpot as a reward for the customer to view the individual advertisement, wherein the individual jackpot corresponds to a sum of a predetermined portion of the advertisement cost for the individual advertisement and a predetermined portion of prize money when there is no winner of a previous drawing, and the customer's view of the individual advertisement is performed through advertisement media that may authenticate identity information about the customer;
choosing a winner who meets the winning condition per drawing and providing the winner with a predetermined portion of the individual jackpot as prize money;
accruing and adjusting the prize money by carrying the prize money over to a winner of a subsequent drawing when the winner is not chosen; and
repeatedly performing the providing step and the adjusting step multiple times until a termination condition for the individual advertisement is met.

2. The method of claim 1, further comprising the step of providing the advertiser with a predetermined portion of a residue of the advertisement cost when the termination condition for the individual advertisement is met and the advertisement, cost for the individual advertisement does not run short.

3. The method of claim 1, further comprising the step of notifying of a result of the choice or non-choice of the winner.

4. The method of claim 1, wherein the advertisement media includes an online advertisement server and offline advertisement media that may identify the customer.

5. The method of claim 1, wherein the winning condition includes a turn of view of advertisement by the customer and a particular event.

6. The method of claim 5, wherein the particular event includes at least one of a weather, a stock price, and an event published by a news or newspaper.

7. The method of claim 1, wherein the termination condition for the individual advertisement includes any one of: the number of times, as set, of choice of the winner of the individual advertisement≦the number of times of choice of the winner; the advertisement cost, as set, for the individual advertisement≦the prize money awarded to the winner; the number, as set, of customers of the individual advertisement≦the number of customers who view the individual advertisement; and the number of target customers after a predetermined time>the number of customers viewing.

8. The method of claim 1, wherein the setting step further includes the steps of setting a proper customer for the individual advertisement, and the step of providing the chance includes blocking the chance unless the ID information about the customer who views the individual advertisement shows that the customer is the proper customer.

9. The method of claim 1, wherein the providing step is choosing the winner within a time set by the advertiser.

10. The method of claim 1, further comprising the steps of:
providing a chance to enter for a higher jackpot to the customer who viewed the individual advertisement after choosing the winner, wherein the higher jackpot is configured hi a multi-level hierarchical structure, and the higher jackpot corresponds to a sum of a predetermined portion of the individual advertisement cost for multiple jackpots belonging to a lowest level in the multi-level hierarchical structure, a predetermined portion of prize money for multiple lower jackpots belonging to the higher jackpot, and a predetermined ratio of prize money when there is no winner in a previous drawing for the higher jackpot;
choosing a winner who meets a preset winning condition and providing the winner with a predetermined portion of the higher jackpot as prize money; and
accruing and adjusting the prize money by carrying the prize money over to a winner of a subsequent drawing for the higher jackpot unless the winner for the higher jackpot is chosen.

11. The method of claim 10, wherein the higher jackpot includes a group jackpot including multiple individual advertisements and a global jackpot including multiple group jackpots.

12. The method of claim 11, wherein when an accrued amount for the group jackpot or the global jackpot reaches a predetermined amount, a winner is chosen for the group jackpot or the global jackpot.

13. The method of claim 12, wherein the accrued amount for the higher jackpot is an amount accrued for a time between when a winner of a previous drawing is chosen for the group jackpot or the global jackpot and when a winner of a subsequent drawing is chosen for the group jackpot or the global jackpot.

14. The method of claim 11, wherein the setting step is setting a plurality of group jackpots associated with the individual advertisement, and the step of providing the chance to enter for the higher jackpot is providing a chance to enter for each of a plurality of group jackpots associated with the individual advertisement.

15. The method of claim 11, wherein the step of providing the chance to enter for the higher jackpot is providing the chance to enter for the group jackpot when the number of times of view of multiple individual advertisements belonging to the group jackpot is a predetermined number or more or providing the chance to enter for the global jackpot when the number of entries for the multiple group jackpots is a predetermined number or more.

16. The method of claim 11, wherein the winning condition for the higher jackpot includes a turn of entry for the jackpot and a particular event.

17. The method of claim 11, wherein the step of providing the predetermined portion of the individual jackpot as the reward or the step of accruing and adjusting the prize money for the individual jackpot is providing a predetermined portion of the prize money for the individual jackpot as a dividend of the group jackpot and the step of providing the predetermined portion of the higher jackpot as the prize money or the step of accruing and adjusting the prize money for the higher jackpot is providing a predetermined portion of the prize money for the group jackpot as a dividend of the global jackpot.

18. The method of claim 11, wherein the step of providing the predetermined portion of the higher jackpot as the prize money is providing the advertiser with a predetermined portion of the group jackpot or a predetermined portion of the global jackpot as a reward.

19. A jackpot marketing advertisement server, comprising:
an advertisement manager setting a jackpot advertisement condition for an individual advertisement by an advertiser, wherein the jackpot advertisement condition includes the number of drawings of a winner, a winning condition per drawing, and prize money amount per drawing, and wherein a sum of prize money amounts is the same or smaller than an advertisement cost for the individual advertisement; and
an individual jackpot manager providing a chance to enter for an individual jackpot as a reward for the customer to view the individual advertisement, choosing a winner who meets the winning condition per drawing and providing the winner with a predetermined portion of the individual jackpot as prize money, accruing and adjusting the prize money by carrying the prize money over to a winner of a subsequent drawing when the winner is not chosen, and repeatedly performing the providing step and the adjusting step multiple times until a termination condition for the individual advertisement is met, wherein the individual jackpot corresponds to a sum of a predetermined portion of the advertisement cost for the individual advertisement and a predetermined portion of prize money when there is no winner of a previous drawing, and the customer's view of the individual advertisement is performed through advertisement media that may authenticate identity information about the customer.

20. The jackpot marketing advertisement server of claim 19, wherein the individual jackpot manager provides the advertiser with a predetermined portion of a residue of the advertisement cost when the termination condition for the individual advertisement is met and the advertisement cost for the individual advertisement does not run short.

21.-38. (canceled)
